(19) United States
(12) Patent Application Publication
(10) Pub. No.: US 2019/0020441 A1
(43) Pub. Date: Jan. 17, 2019

(54) Out-of-Band Communication in a Serial Communication Environment

(71) Applicant: Avago Technologies General IP (Singapore) Pte. Ltd., Singapore (SG)

(72) Inventor: Velu PILLAI, Austin, TX (US)

(73) Assignee: Avago Technologies General IP (Singapore) Pte. Ltd., Singapore (SG)

(21) Appl. No.: 15/795,737

(22) Filed: Oct. 27, 2017

Related U.S. Application Data
(60) Provisional application No. 62/532,073, filed on Jul. 13, 2017.

(51) Int. Cl. H04L 1/00; H04L 12/721

(52) U.S. Cl. CPC H04L 1/0006; H04L 45/66

(57) ABSTRACT

The present disclosure describes a serializer and a deserializer. The serializer can receive a sequence of information in a parallel format and control information over a serial interface from a host device. The serializer converts the sequence of information in the parallel format to provide the sequence of information in a serial format to the deserializer which converts the sequence of information in to serial format to the sequence of information in the parallel format. The serializer passes through the control information to provide the control information to the deserializer which is similarly passed through by the deserializer. The control information can include one or more control packets and/or one or more link pulses to train one or more other serializers and/or one or more other deserializers communicating with each other over a communication channel.

### CROSS-REFERENCE TO RELATED APPLICATIONS

The present application claims the benefit of U.S. Provisional Patent Appl. No. 62/532,073, filed Jul. 13, 2017, which is incorporated herein by reference in its entirety.

### BACKGROUND

### Field of Disclosure

The present disclosure relates generally to a serial communication environment, and including out-of-band communication for communicating control information within the serial communication environment.

### Related Art

Link training is a technique used in high speed serializer-deserializer (SERDES) communication and is part of the Ethernet Standard (e.g., IEEE802.3) specifications. Link training provides a protocol for a device to communicate over a point-to-point link, using in-band information, to a remote link partner (LP) to jointly improve the bit-error rate (BER) over the link and/or interference on adjacent channels caused by the link. Existing link training solutions perform link training only once, during startup or initialization of the link and, as a result, are limited in their applications.

### BRIEF DESCRIPTION OF THE DRAWINGS/FIGURES

Embodiments of the disclosure are described with reference to the accompanying drawings. In the drawings, like reference numbers indicate identical or functionally similar elements. Additionally, the left most digit(s) of a reference number identifies the drawing in which the reference number first appears. In the accompanying drawings:

FIG. 1 illustrates a first communication environment according to an exemplary embodiment of the present disclosure;

FIG. 2 illustrates a serial interface within the serial communication environment according to an exemplary embodiment of the present disclosure;

FIG. 3A illustrates a block diagram of an exemplary serializer within the serial communication environment according to an exemplary embodiment of the present disclosure;

FIG. 3B illustrates a block diagram of an exemplary serializer within the serial communication environment according to an exemplary embodiment of the present disclosure; and

FIG. 4 illustrates a second communication environment according to an exemplary embodiment of the present disclosure.

The disclosure will now be described with reference to the accompanying drawings. In the drawings, like reference numbers generally indicate identical, functionally similar, and/or structurally similar elements. The drawing in which an element first appears is indicated by the leftmost digit(s) in the reference number.

### DETAILED DESCRIPTION OF THE DISCLOSURE

### Overview

The present disclosure describes a serializer and a deserializer. The serializer can receive a sequence of information in a parallel format and control information over a serial interface from a host device. The serializer converts the sequence of information in the parallel format to provide the sequence of information in a serial format to the deserializer which converts the sequence of information in the serial format to the sequence of information in the parallel format. The serializer passes through the control information to provide the control information to the deserializer which is similarly passed through by the deserializer. The control information can include one or more control packets and/or one or more link pulses to train one or more other serializers and/or one or more other deserializers communicating with each other over a communication channel.

First Serial Communication Environment

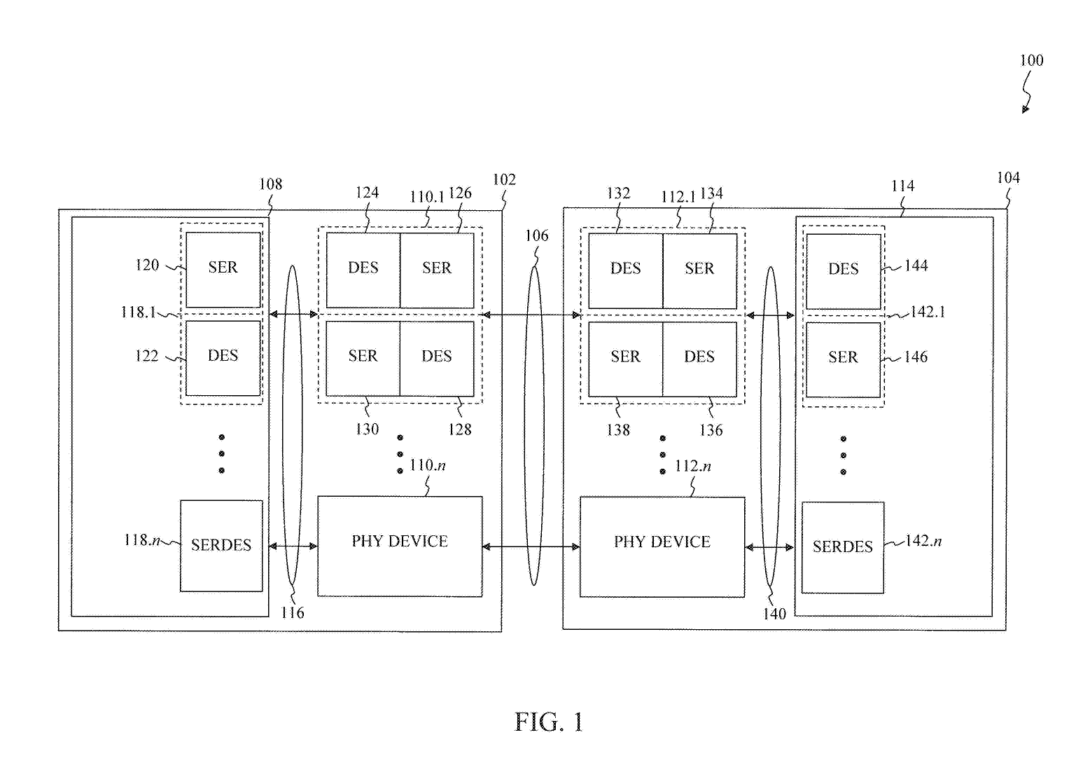

FIG. 1 illustrates a first communication environment according to an exemplary embodiment of the present disclosure. A serial communication environment 100, such as a data center or an enterprise campus to provide some examples, provides serial communication of information between a first electronic device 102 and a second electronic device 104 over a communication channel 106, such as a copper cable, a fiber optic cable, or a copper backplane to provide some examples. As illustrated in FIG. 1, the first electronic device 102 includes a host device 108 and physical layer (PHY) devices 110.1 through 110.n and the second electronic device 104 includes PHY devices 112.1 through 112.n and a host device 114.

The host device 108 of the first electronic device 102 communicates information with the PHY devices 110.1 through 110.n in the serial format over a first serial interface 116. In the exemplary embodiment illustrated in FIG. 1, the host device 108 includes SERDES devices 118.1 through 118.n, each of the SERDES devices 118.1 through 118.n including a serializer 120 and a deserializer 122. The serializer 120 converts information received from host device 108 in a parallel format to the serial format for communication to a corresponding PHY device from among the PHY devices 110.1 through 110.n. Similarly, the deserializer 122 converts information received in the serial format from the corresponding PHY device from among the PHY devices 110.1 through 110.n to the parallel format for delivery to the host device 108. In an exemplary embodiment, the host device 108 can represent a network switch, an application specific integrated circuit (NIC), a network interface controller (NIC), a network processor, a memory device, or any other suitable device that will be apparent to those skilled in the relevant art(s) without departing from the spirit and scope of the present disclosure.

The PHY devices 110.1 through 110.n of the first electronic device 102 communicate information between the host device 108 and the PHY devices 112.1 through 112.n of the second electronic device 104 in the serial format. In an exemplary embodiment, the information is communicated between the PHY devices 110.1 through 110.n and the PHY devices 112.1 through 112.n in accordance with a version of an Institute of Electrical and Electronics Engineers (IEEE) 802.3 communication standard or protocol, also referred as Ethernet, such as 50G Ethernet, 100G Ethernet, 200G Ethernet, and/or 400G Ethernet to provide some examples. In this exemplary embodiment, the information is communicated between the PHY devices 110.1 through 110.n and the PHY devices 112.1 through 112.n as one or more Ethernet packets having Ethernet headers and Ethernet frames.

In the exemplary embodiment illustrated in FIG. 1, each of the PHY devices 110.1 through 110.n includes a deserializer 124, serializer 126, deserializer 128, and a serializer 130. The deserializer 124 converts information received in the serial format from a corresponding SERDES device from among the SERDES devices 118.1 through 118.n over the first serial interface 116 to the parallel format for delivery to the serializer 126. Thereafter, the serializer 126 converts the information received in the parallel format from the deserializer 124 into the serial format for communication to a corresponding PHY device from among the PHY devices 112.1 through 112.n over the communication channel 106. Similarly, the deserializer 128 converts information received in the serial format from the corresponding PHY device from among the PHY devices 112.1 through 112.n over the communication channel 106 to the parallel format for delivery to the serializer 130. Thereafter, the serializer 130 converts the information received in the parallel format from the deserializer 128 to the serial format for communication the corresponding SERDES device from among the SERDES devices 118.1 through 118.n over the first serial interface 116.

The PHY devices 112.1 through 112.n of the second electronic device 104 communicate information between the PHY devices 110.1 through 110.n of the first electronic device 102 and the host device 114 and in the serial format. In an exemplary embodiment, the information is communicated between the PHY devices 112.1 through 112.n and the PHY devices 110.1 through 110.n in accordance with a version of an Institute of Electrical and Electronics Engineers (IEEE) 802.3 communication standard or protocol, also referred as Ethernet, such as 50G Ethernet, 100G Ethernet, 200G Ethernet, and/or 400G Ethernet to provide some examples. In this exemplary embodiment, the information is communicated between the PHY devices 112.1 through 112.n and the PHY devices 110.1 through 110.n as one or more Ethernet packets having Ethernet headers and Ethernet frames.

In the exemplary embodiment illustrated in FIG. 1, each of the PHY devices 112.1 through 112.n includes a deserializer 132, serializer 134, deserializer 136, and a serializer 138. The deserializer 132 converts information received in the serial format from a corresponding PHY device from among the PHY devices 110.1 through 110.n over the communication channel 106 to the parallel format for delivery to the serializer 134. Thereafter, the serializer 134 converts the information received in the parallel format from the deserializer 132 into the serial format for communication to a corresponding SERDES device from among SERDES devices 142.1 through 142.n over a second serial interface 140. Similarly, the deserializer 136 converts information received in the serial format from the corresponding SERDES device from among SERDES devices 142.1 through 142.n over the second serial interface 140 to the parallel format for delivery to the serializer 138. Thereafter, the serializer 138 converts the information received in the parallel format from the deserializer 136 to the serial format for communication to the corresponding PHY device from among the PHY devices 110.1 through 110.n over the communication channel 106.

The host device 114 of the second electronic device 104 communicates information with the PHY devices 112.1 through 112.n in the serial format over the second serial interface 140. In the exemplary embodiment illustrated in FIG. 1, the host device 114 includes SERDES devices 142.1 through 142.n, each of the SERDES devices 142.1 through 142.n including a deserializer 144 and a serializer 146. The deserializer 144 converts information received in the serial format from the corresponding PHY device from among the PHY devices 112.1 through 112.n to the parallel format for delivery to the host device 114. Similarly, the serializer 146 converts information received from the host device 114 in the parallel format to the serial format for communication to a corresponding PHY device from among the PHY devices 112.1 through 112.n. In an exemplary embodiment, the host device 114 can represent a network switch, an application specific integrated circuit (NIC), a network interface controller (NIC), a network processor, a memory device, or any other suitable device that will be apparent to those skilled in the relevant art(s) without departing from the spirit and scope of the present disclosure.

Exemplary Serial Interface

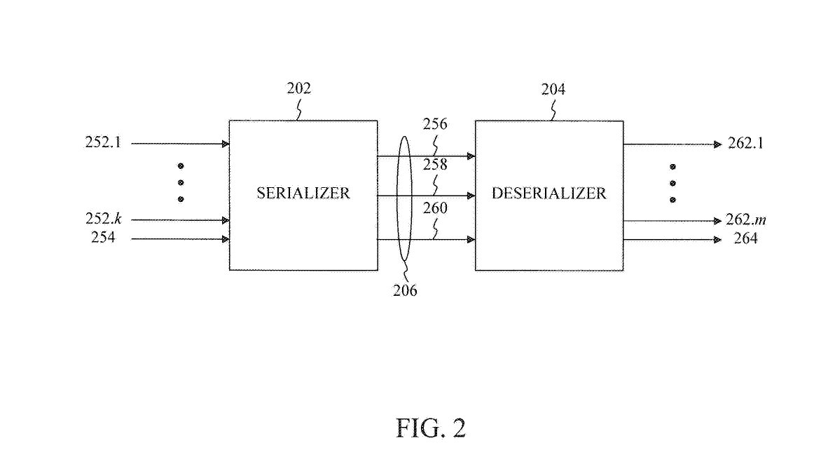

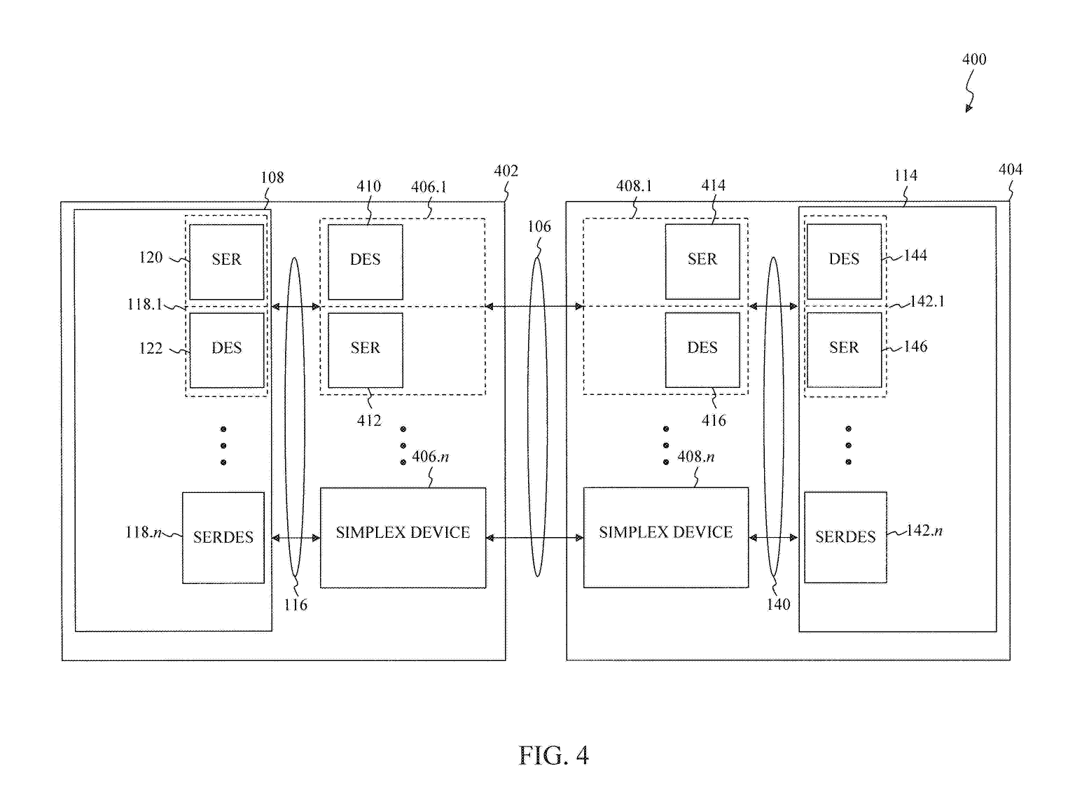

FIG. 2 illustrates a serial interface within the serial communication environment according to an exemplary embodiment of the present disclosure. A serializer 202 converts information received in the parallel format into a serial format for communication to a deserializer 204 over a serial interface 206. The deserializer 204 converts the information received from the serializer 202 in the serial format into the parallel format. The serializer 202 can represent an exemplary embodiment of the serializer device 120, serializer device 130, serializer device 134, the serializer device 146, the serializer device 412, and/or the serializer device 414. The deserializer 204 can represent an exemplary embodiment of the deserializer device 122, the deserializer device 124, the deserializer device 136, the deserializer device 144, the deserializer device 410, and/or the deserializer device 416. The deserializer device 410, the serializer device 412, the serializer device 414, and the deserializer device 416 are to be described in further detail below in FIG. 4. The serial interface 206 can represent an exemplary embodiment of the first serial interface 116 and/or the second serial interface 140.

The serializer 202 receives a parallel sequence of information 252.1 through 252.k from a first electronic device, such as the host device 108, the deserializer device 128, the deserializer device 132, and/or the host device 114 to provide some examples. The parallel sequence of information 252.1 through 252.k can include one or more data packets to be transmitted to the deserializer 204. In an exemplary embodiment, the parallel sequence of information 252.1 through 252.k can include a read command to read register data from one or more registers of the deserializer 204 and/or the other electronic devices communicatively coupled to the deserializer 204 and/or a write command to write register data to the one or more registers of the deserializer 204 and/or the other electronic devices communicatively coupled to the deserializer 204. In this exemplary embodiment, the read command and/or the write command can include: (1) preambles of thirty-two (32) bits at a logical one; (2) sixteen (16) control bits to identify: starts of the read command and/or the write command, the read command and/or the write command, an address of a host device, such as the host device 108 or the host device 114 to provide some examples, requesting the read command and/or the write command, one or more addresses of the one or more registers; and (3) sixteen (16) bits of the register data.

Similarly, the serializer 202 receives control information 254 from the first electronic device. The control information 254 can include one or more control packets and/or one or more link pulses, such as one or more fast link pulse (FLPs) or one or more normal link pulse (NLPs) to provide some examples, to identify the configuration and/or the operation of the deserializer 204 and/or other electronic devices communicatively coupled to the deserializer 204, such as the PHY devices 110.1 through 110.n, the PHY devices 112.1 through 112.n, the SERDES devices 118.1 through 118.n, and/or the SERDES devices 142.1 through 142.n to provide some examples. In some situations, the one or more link pulses can include one or more link code words (LCWs). In an exemplary embodiment, the control information 254 can be used to implement an auto-negotiation procedure to allow connected devices, such as the PHY devices 110.1 through 110.n and the PHY devices 112.1 through 112.n to provide an example, to choose common communication parameters, such as speed, error correction, duplex mode, and/or flow control to provide some examples, to establish one or more communication links to communicate information over a communication channel, such as the communication channel 106.

In some situations, the control information 254 can be utilized to train the PHY devices 110.1 through 110.n to communicate with the PHY devices 112.1 through 112.n over the communication channel 106 and/or the PHY devices 112.1 through 112.n to communicate with the PHY devices 110.1 through 110.n over the communication channel 106. In these situations, the PHY devices 110.1 through 110.n configure their corresponding serializer device 126 and/or the PHY devices 112.1 through 112.n configure their corresponding deserializer device 132 and/or the PHY devices 112.1 through 112.n configure their corresponding serializer device 138 and/or the PHY devices 110.1 through 110.n configure their corresponding deserializer device 128 to optimize their electrical performance by through a unilateral and/or bilateral exchange of the control information 254.

Moreover, the control information 254 can be used to control and/or configure one or more advanced features of a serial communication environment, such as the serial communication environment 100 to provide an example. These advanced features include features supported by the Flexible Ethernet (FlexE) communication protocol such as bonding of multiple communication links within the communication channel 106, sub-rating of communication links within the communication channel 106, and/or channelization of communication links within the communication channel 106 to provide some examples. These advanced features also include features supported by the MAC Security standard (MACsec) such as Secure Connectivity Associations and/or Security Associations, including Security Association Keys (SAKs), to provide some examples.

Thereafter, the serializer 202 converts the parallel sequence of information 252.1 through 252.k from the parallel format to the serial format in accordance with a clocking signal to provide a serial sequence of information 256 and a clocking signal 258 to the deserializer 204. In some situations, the serializer 202 can be implemented as an embedded clock device to serialize the parallel sequence of information 252.1 through 252.k and the clocking signal into the serial sequence of information 256. In these situations, the serializer 202 does not provide the clocking signal 258. Moreover, the serializer 202 routes the control information 254 to provide control information 260 to the deserializer 204. In an exemplary embodiment, the serializer 202 can simply pass-through the control information 254 to provide the control information 260 to the deserializer 204 without further processing of the control information 254.

In an exemplary embodiment, the serial sequence of information 256 can be characterized as being an in-band communication and the control information 260 can be characterized as being an out-of-band communication in reference to the serial sequence of information 256. In this exemplary embodiment, the host device 108 or the host device 114, via the serializer 202, can simultaneously, or near simultaneously, identify the configuration and/or the operation of the deserializer 204 and/or the other electronic devices communicatively coupled to the deserializer 204, such as the PHY devices 110.1 through 110.n, the PHY devices 112.1 through 112.n, the SERDES devices 118.1 through 118.n, and/or the SERDES devices 142.1 through 142.n to provide some examples, and send the parallel sequence of information 252.1 through 252.k. For example, the host device 108 or the host device 114, via the serializer 202, can simultaneously, or near simultaneously, train the PHY devices 112.1 through 112.n to communicate with the PHY devices 110.1 through 110.n over the communication channel 106 and/or the PHY devices 110.1 through 110.n to communicate with the PHY devices 112.1 through 112.n over the communication channel 106, respectively, and send the parallel sequence of information 252.1 through 252.k.

The deserializer 204 receives the serial sequence of information 256, and the clocking signal 258 and the control information 260 from the serializer 202 over the serial interface 206. Thereafter, the deserializer 204 converts the serial sequence of information 256 from the serial format to the parallel format in accordance with the clocking signal 258 to provide a parallel sequence of information 262.1 through 262.m. Moreover, the deserializer 204 routes the control information 260 to provide control information 264 to a second electronic device, such as the host device 108, the host device 114, the serializer device 126, and/or the serializer device 138 to provide some examples. In an exemplary embodiment, the deserializer 204 can simply pass-through the control information 260 to provide the control information 264 to the second electronic without further processing of the control information 254.

Exemplary Serializer

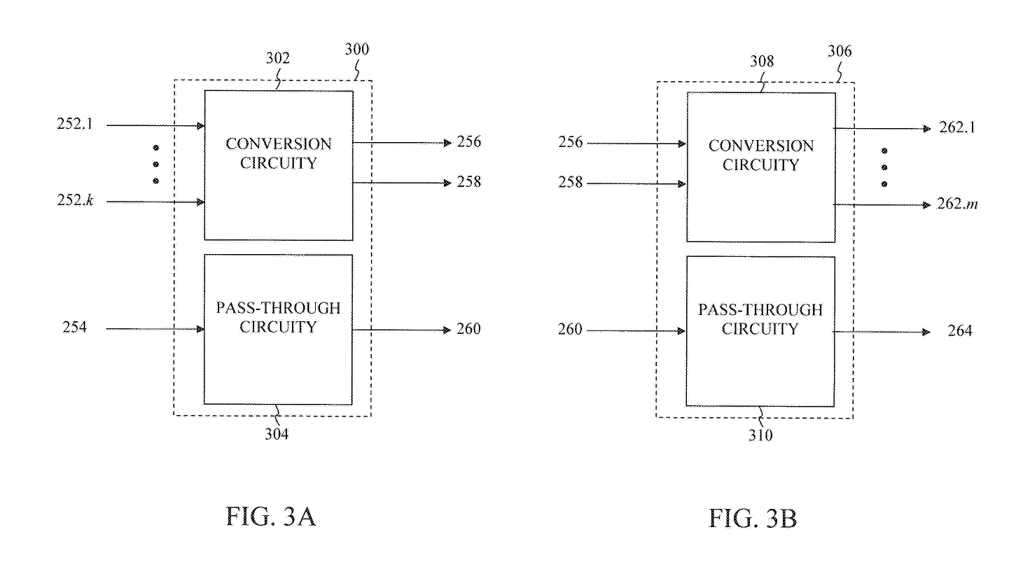

FIG. 3A illustrates a block diagram of an exemplary serializer within the serial communication environment according to an exemplary embodiment of the present disclosure. A serializer 300 converts information received in the parallel format into the serial format for communication to a deserializer, such as the deserializer 204 to provide an example, over a serial interface, such as the serial interface 206 to provide an example. Similarly, the serializer 300 passes through control information to the deserializer over the serial interface. In the exemplary embodiment illustrated in FIG. 3A, the serializer 300 includes conversion circuitry 302 and pass-through circuitry 304. The serializer 300 can represent an exemplary embodiment of the serializer 202.

The conversion circuitry 302 receives the parallel sequence of information 252.1 through 252.k from a first group of input ports from among multiple input ports. Thereafter, the conversion circuitry 302 converts the parallel sequence of information 252.1 through 252.k from the parallel format to the serial format in accordance with a clocking signal to provide the serial sequence of information 256 and the clocking signal 258 to a first group of output ports from among multiple output ports. In some situations, the conversion circuitry 302 can serialize the parallel sequence of information 252.1 through 252.k and the clocking signal into the serial sequence of information 256. In these situations, the conversion circuitry 302 does not provide the clocking signal 258.

The pass-through circuitry 304 receives the control information 254 from a second input port from among the multiple input ports. The pass-through circuitry 304 routes the control information 254 to provide the control information 260 to a second output port from among the multiple output ports. In an exemplary embodiment, the serializer 202 can simply pass-through the control information 254 to provide the control information 260 to the second output port without further processing of the control information 254.

Exemplary Deserializer

FIG. 3B illustrates a block diagram of an exemplary serializer within the serial communication environment according to an exemplary embodiment of the present disclosure. A deserializer 306 converts information received in the serial format into the parallel format for communication to a serializer, such as the serializer 202 to provide an example, over a serial interface, such as the serial interface 206 to provide an example. Similarly, the deserializer 306 passes through control information to the serializer over the serial interface. In the exemplary embodiment illustrated in FIG. 3B, the deserializer 306 includes conversion circuitry 308 and pass-through circuitry 310. The deserializer 306 can represent an exemplary embodiment of the deserializer 204.

The conversion circuitry 308 receives the serial sequence of information 256 and the clocking signal 258 from a first group of input ports from among multiple input ports. Thereafter, the conversion circuitry 308 converts the serial sequence of information 256 from the serial format to the parallel format in accordance with the clocking signal 258 to provide the parallel sequence of information 262.1 through 262.m to a first group of output ports from among multiple output ports.

The pass-through circuitry 310 receives the control information 260 from a second input port from among the multiple input ports. The pass-through circuitry 310 routes the control information 260 to provide the control information 264 to a second output port from among the multiple output ports. In an exemplary embodiment, the serializer 202 can simply pass-through the control information 260 to provide the control information 264 to the second output port without further processing of the control information 260.

Second Exemplary Communication Environment

FIG. 4 illustrates a second communication environment according to an exemplary embodiment of the present disclosure. A serial communication environment 400, such as a data center or an enterprise campus to provide some examples, provides serial communication of information between a first electronic device 402 and a second electronic device 404 over the communication channel 106. As illustrated in FIG. 4, the first electronic device 402 includes the host device 108 and simplex devices 406.1 through 406.n and the second electronic device 104 includes simplex devices 408.1 through 408.n and the host device 114. As to be discussed below, a simplex device, such as one of the simplex devices 406.1 through 406.n and/or the simplex devices 408.1 through 408.n, includes a serializer without a corresponding deserializer and a deserializer without a corresponding serializer. In contrast, a PHY device, such as one of the PHY devices 110.1 through 110.n and/or the PHY devices 112.1 through 112.n n, includes a serializer with a corresponding deserializer and a deserializer with a corresponding serializer. However, those skilled in the relevant art(s) will recognize that the first electronic device 402 and the second electronic device 404 can include the PHY devices 110.1 through 110.n and the PHY devices 112.1 through 112.n, respectively, as discussed above in FIG. 1 without departing from the spirit and scope of the present disclosure.

The host device 108 of the first electronic device 402 communicates information with the simplex devices 406.1 through 406.n in the serial format over the first serial interface 116 in a substantially similar manner as the host device 108 of the first electronic device 402 communicates information with the PHY devices 110.1 through 110.n as described above in FIG. 1.

The simplex devices 406.1 through 406.n of the first electronic device 402 communicate information between the host device 108 and the simplex devices 408.1 through 408.n of the second electronic device 404. In the exemplary embodiment illustrated in FIG. 4, each of the simplex devices 406.1 through 406.n includes a deserializer 410 and a serializer 412. The deserializer 410 converts information received in the serial format from a corresponding SERDES device from among the SERDES devices 118.1 through 118.n over the first serial interface 116 to the parallel format for delivery to a corresponding simplex device from among the simplex devices 408.1 through 408.n. Similarly, the serializer 412 converts information received from the corresponding simplex device from among the simplex devices 408.1 through 408.n over the communication channel 106 to the serial format for communication to corresponding SERDES device from among the SERDES devices 118.1 through 118.n over the first serial interface 116.

As discussed above in FIG. 2, the serializer 202 and the deserializer 204 can represent exemplary embodiments of the serializer 414 and the deserializer 410, respectively. As such, the deserializer 410 receives the control information 254, such as the one or more control packets and/or one or more link pulses as described above in FIG. 2, from the host device 108 as the control information 260 to identify the configuration and/or the operation of the simplex devices 408.1 through 408.n. Moreover, the deserializer 410 routes the control information 260 to provide the control information 264 for delivery to a corresponding simplex device from among the simplex devices 408.1 through 408.n. In an exemplary embodiment, the deserializer 410 can simply pass-through the control information 260 to provide the control information 264 to the corresponding simplex device from among the simplex devices 408.1 through 408.n without further processing of the control information 254. In some situations, the control information 260 can be utilized to train the simplex devices 406.1 through 406.n to communicate with the simplex devices 408.1 through 408.n over the communication channel 106 and/or the simplex devices 408.1 through 408.n to communicate with the simplex devices 406.1 through 406.n over the communication channel 106. In these situations, the simplex devices 406.1 through 406.n configure their corresponding deserializer 410 and/or the simplex devices 408.1 through 408.n configure their corresponding serializer device 414 to optimize their electrical performance through a unilateral and/or bilateral exchange of the control information 260.

The simplex devices 408.1 through 408.n of the second electronic device 404 communicate information between the host device 114 and the simplex devices 406.1 through 406.n of the first electronic device 402. In the exemplary embodiment illustrated in FIG. 4, each of the simplex devices 408.1 through 408.n includes a serializer 414 and a deserializer 416. The serializer 414 converts information received from a corresponding simplex device from among the simplex devices 406.1 through 406.n over the communication channel 106 to the serial format for communication to a corresponding SERDES device from among SERDES devices 142.1 through 142.n over a second serial interface 140. The deserializer 124 converts information received in the serial format from the corresponding SERDES device from among the SERDES devices 142.1 through 142.n over the second serial interface 140 to the parallel format for delivery to a corresponding simplex device from among the simplex devices 406.1 through 406.n.

As discussed above in FIG. 2, the serializer 202 and the deserializer 204 can represent exemplary embodiments of the serializer 414 and the deserializer 416, respectively. As such, the deserializer 416 receives the control information 254, such as the one or more control packets and/or one or more link pulses as described above in FIG. 2, from the host device 114 as the control information 260 to identify the configuration and/or the operation of the simplex devices 406.1 through 406.n. Moreover, the deserializer 416 routes the control information 260 to provide the control information 264 for delivery to a corresponding simplex device from among the simplex devices 406.1 through 406.n. In an exemplary embodiment, the deserializer 416 can simply pass-through the control information 260 to provide the control information 264 to the corresponding simplex device from among the simplex devices 406.1 through 406.n without further processing of the control information 254. In some situations, the control information 260 can be utilized to train the simplex devices 406.1 through 406.n to communicate with the simplex devices 408.1 through 408.n over the communication channel 106 and/or the simplex devices 408.1 through 408.n to communicate with the simplex devices 406.1 through 406.n over the communication channel 106. In these situations, the simplex devices 406.1 through 406.n configure their corresponding serializer 412 and/or the simplex devices 408.1 through 408.n configure their corresponding deserializer device 416 to optimize their electrical performance through a unilateral and/or bilateral exchange of the control information 260.

The host device 114 of the second electronic device 404 communicates information with the simplex devices 408.1 through 408.n in the serial format over the second serial interface 140 in a substantially similar manner as the host device 114 of the second electronic device 104 communicates information with the PHY devices 112.1 through 112.n as described above in FIG. 1.

### CONCLUSION

The Detailed Description referred to accompanying figures to illustrate exemplary embodiments consistent with the disclosure. References in the disclosure to “an exemplary embodiment” indicates that the exemplary embodiment described include a particular feature, structure, or characteristic, but every exemplary embodiment can not necessarily include the particular feature, structure, or characteristic. Moreover, such phrases are not necessarily referring to the same exemplary embodiment. Further, any feature, structure, or characteristic described in connection with an exemplary embodiment can be included, independently or in any combination, with features, structures, or characteristics of other exemplary embodiments whether or not explicitly described.

The exemplary embodiments described within the disclosure have been provided for illustrative purposes, and are not intend to be limiting. Other exemplary embodiments are possible, and modifications can be made to the exemplary embodiments while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Detailed Description of the exemplary embodiments fully revealed the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based on the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. A serializer, comprising:
conversion circuitry configured to:
receive a parallel sequence of information in a parallel format from a first group of input ports from among a plurality input ports, and
convert the parallel sequence of information from the parallel format to a serial format in accordance with a clocking signal to provide a serial sequence of information and the clocking signal to a first group of output ports from among multiple output ports; and
pass-through circuitry configured to:
receive control information from a second input port from among the plurality input ports, and
pass-through the control information from the second input port to a second output port from among the multiple output ports.

2. The serializer of claim 1, wherein the parallel sequence of information comprises:
a read command to read register data from one or more registers of an electronic device communicatively coupled to the serializer; or
a write command to read register data from the one or more registers of the electronic device.

3. The serializer of claim 1, wherein the control information comprises:
one or more link pulses to train a first physical layer (PHY) device to communicate with a second PHY device over a communication channel.

4. The serializer of claim 3, wherein the communication channel comprises:
a copper cable, a fiber optic cable, or a copper backplane.

5. The serializer of claim 3, wherein the one or more link pulses train a second serializer of the first PHY device to communicate with a deserializer of the second PHY device.

6. The serializer of claim 1, wherein the conversion circuitry is configured to receive the parallel sequence of information from a host device, and
wherein pass-through circuitry is configured to receive the control information from the host device.

7. The serializer of claim 1, wherein the pass-through circuitry is configured to pass-through the control information simultaneously with the conversion circuitry providing the serial sequence of information and the clocking signal.

8. The serializer of claim 1, wherein the pass-through circuitry is configured to receive the control information simultaneously with the conversion circuitry receiving the parallel sequence of information.

9. A deserializer, comprising:
conversion circuitry configured to:
receive a serial sequence of information in a serial format and a clocking signal from a first group of input ports from among a plurality input ports, and
convert the serial sequence of information from the serial format to a parallel format in accordance with the clocking signal to provide a parallel sequence of information to a first group of output ports from among multiple output ports; and
pass-through circuitry configured to:
receive control information from a second input port from among the plurality input ports, and
pass-through the control information from the second input port to a second output port from among the multiple output ports.

10. The deserializer of claim 9, wherein the serial sequence of information comprises:
a read command to read register data from one or more registers of an electronic device communicatively coupled to the deserializer; or
a write command to read register data from the one or more registers of the electronic device.

11. The deserializer of claim 9, wherein the control information comprises:
one or more link pulses to train a first physical layer (PHY) device to communicate with a second PHY device over a communication channel.

12. The deserializer of claim 11, wherein the communication channel comprises:
a copper cable, a fiber optic cable, or a copper backplane.

13. The deserializer of claim 11, wherein the one or more link pulses train a second deserializer of the first PHY device to communicate with a serializer of the second PHY device.

14. The deserializer of claim 9, wherein the conversion circuitry is configured to receive the serial sequence of information from a host device over a serial interface, and
wherein pass-through circuitry is configured to receive the control information from the host device over the serial interface.

15. The deserializer of claim 9, wherein the pass-through circuitry is configured to pass-through the control information simultaneously with the conversion circuitry providing the parallel sequence of information.

16. The deserializer of claim 9, wherein the the pass-through circuitry is configured to receive the control information simultaneously with the conversion circuitry receiving the serial sequence of information.

17. A first electronic device, comprising:
a host device having a first serializer, the first serializer being configured to:
receive a first sequence of information in a parallel format from a first group of input ports from among a first plurality of input ports and control information from a second input port from among the first plurality of input ports,
convert the first sequence of information in the parallel format to a serial format in accordance with a clocking signal to provide a second sequence of information in the serial format and the clocking signal to a first group of output ports from among a first plurality of output ports, and
pass-through the control information from the second input port to a second output port from among the first plurality of output ports; and
a physical layer (PHY) device having a first deserializer and a second serializer, the first deserializer being configured to:
receive the second sequence of information in the serial format and the clocking signal from a first group of input ports from among a second plurality of input ports and the control information from a second input port from among the second plurality of input ports,
convert the second sequence of information in the serial format to the parallel format in accordance with the clocking signal to provide a third sequence of information in the parallel format and the clocking signal to a first group of output ports from among a second plurality of output ports, and
pass-through the control information from the second input port to a second output port from among the second plurality of output ports, and
wherein the second serializer is configured to:
receive the third sequence of information in the parallel format from a first group of input ports from among a third plurality of input ports and the control information from a second input port from among the third plurality of input ports,
convert the first sequence of information in the parallel format to the serial format in accordance with the clocking signal to provide a fourth sequence of information in the serial format and the clocking signal to a first group of output ports from among a third plurality of output ports, and
pass-through the control information from the second input port to a second output port from among the third plurality of output ports.

18. The first electronic device of claim 18, wherein the control information comprises:
one or more link pulses to train a second deserializer to communicate with the second serializer over a communication channel.

19. The first electronic device of claim 18, wherein the second serializer is further configured to provide the fourth sequence of information to a second electronic device over a communication channel in accordance with a version of an Ethernet communication standard or protocol.

20. The first electronic device of claim 19, wherein the version of the Ethernet communication standard or protocol comprises:
500 Ethernet, 100G Ethernet, 2000 Ethernet, or 400G Ethernet.
